(19) United States
(12) Patent Application Publication
(10) Pub. No.: US 2026/0312748 A1
(43) Pub. Date: Oct. 8, 2026

(54) SIDELINK AND DOUBLE SIDED ROUND TRIP TIME POSITIONING

(71) Applicant: Apple Inc., Cupertino, CA (US)

(72) Inventors: Oghenekome Oteri, San Diego, CA (US); Ankit Bhamri, Bad Nauheim (DE); Chunxuan Ye, San Diego, CA (US); Dawei Zhang, Saratoga, CA (US); Haitong Sun, Cupertino, CA (US); Wei Zeng, Saratoga, CA (US)

(21) Appl. No.: 19/482,843

(22) PCT Filed: May 10, 2024
(86) PCT No.: PCT/US2024/028894

§ 371 Date: Nov. 10, 2025

Related U.S. Application Data
(60) Provisional application No. 63/466,233, filed on May 12, 2023.

(51) Int. Cl. H04L 5/00; H04W 56/00; H04W 64/00; H04W 72/25

(52) U.S. Cl. CPC H04L 5/0037; H04L 5/0094; H04W 56/0065; H04W 64/006; H04W 72/25

(57) ABSTRACT

Disclosed are methods, systems, and computer-readable medium to perform operations for sidelink positioning including transmitting a sidelink positioning reference signal (SL-PRS) transmission to another UE, receiving feedback information from the other UE that was generated based on a measured signal strength of the transmitted SL-PRS transmission, and configuring an SL-PRS multiplexing group based on the received feedback information.

### PRIORITY CLAIM

The present application claims priority of U.S. Provisional Application No. 63/466,233, filed on May 12, 2023, entitled “SIDELINK AND DOUBLE SIDED RTT POSITIONING,” which is herein incorporated by reference in its entirety.

### BACKGROUND

Wireless communication networks provide integrated communication platforms and telecommunication services to wireless user devices. Example telecommunication services include telephony, data (e.g., voice, audio, and/or video data), messaging, and/or other services. The wireless communication networks have wireless access nodes that exchange wireless signals with the wireless user devices using wireless network protocols, such as protocols described in various telecommunication standards promulgated by the Third Generation Partnership Project (3GPP). Example wireless communication networks include time division multiple access (TDMA) networks, frequency-division multiple access (FDMA) networks, orthogonal frequency-division multiple access (OFDMA) networks, Long Term Evolution (LTE), and Fifth Generation New Radio (5G NR). The wireless communication networks facilitate mobile broadband service using technologies such as OFDM, multiple input multiple output (MIMO), advanced channel coding, massive MIMO, beamforming, and/or other features.

### SUMMARY

In accordance with one aspect of the present disclosure, a method for sidelink positioning is disclosed. In one aspect, the method can include actions of receiving a request for sidelink positioning reference signal (SL-PRS) transmission from another UE, and transmitting an SL-PRS transmission using any symbol or slot within a shared resource pool containing a one or more physical sidelink shared channel (PSSCH)/physical sidelink feedback channel (PSFCH) transmissions.

Other aspects includes apparatuses, systems, and computer programs for performing the actions of the aforementioned method.

The innovative method can include other optional features. For example, in some implementations, the bandwidth of the SL-PRS is less than or equal to the bandwidth of the shared resource pool.

In some implementations, the comb-based multiplexing is used with SL-PRS T-F resources.

In some implementations, the bandwidth of the SL-PRS is greater than the bandwidth of PSSCH.

In some implementations, comb-based multiplexing occurs with SL-PRS time and frequency (T-F) resources.

In some implementations, transmitting an SL-PRS transmission using any symbol or dedicated slot within a shared resource pool containing a one or more PSSCH/PSFCH transmissions can include transmitting an SL-PRS transmission using any symbol or dedicated slot within a shared resource pool containing multiple PSSCH/PSFCH transmissions.

In some implementations, the bandwidth of the SL-PRS is greater than the bandwidth of each of the PSSCH transmissions.

In some implementations, the slot of the shared resource pool is a dedicated slot.

According to another innovative aspect of the present disclosure, a method for sidelink positioning is disclosed. In one aspect, the method can include actions of receiving sidelink positioning reference signal (SL-PRS) transmission from one or more other UEs, measuring a signal strength of each of the received SL-PRS transmissions, and transmitting feedback information to one or more devices based on the measured signal strength of each of the received SL-PRS transmission.

Other aspects includes apparatuses, systems, and computer programs for performing the actions of the aforementioned method.

The innovative method can include other optional features. For example, in some implementations, the feedback information is transmitted using sidelink control information (SCI).

In some implementations, receiving SL-PRS transmission from one or more other UEs can include receiving SL-PRS transmission from one other UE.

In some implementations, the feedback information comprises one or more UE identifiers that each correspond to a UE from which an SL-PRS transmission was received that satisfied a predetermined signal strength threshold.

In some implementations, the UE identifier can include a UEID or a session ID.

In some implementations, the one or more devices comprises a Location management function (LMF), a sidelink LMF (SL-LMF), or server UE.

In some implementations, the other one or more devices comprises the other UEs.

In some implementations, the signal strength measured is a reference signal received power (RSRP) strength.

In some implementations, the signal strength measured is a reference strength signal indicator (RSSI).

According to another innovative aspect of the present disclosure, another method sidelink positioning is disclosed. In one aspect, the method can include transmitting a sidelink positioning reference signal (SL-PRS) transmission to another UE, receiving feedback information from the other UE that was generated based on a measured signal strength of the transmitted SL-PRS transmission, and configuring an SL-PRS multiplexing group based on the received feedback information.

Other aspects includes apparatuses, systems, and computer programs for performing the actions of the aforementioned method.

The innovative method can include other optional features. For example, in some implementations, the feedback information is transmitted using sidelink control information (SCI).

In some implementations, the feedback information comprises one or more UE identifiers that each correspond to a UE that transmitted an SL-PRS transmission that satisfied a predetermined signal strength threshold.

In some implementations, the UE identifier can include a UEID or a session ID.

In some implementations, the signal strength measured is a reference signal received power (RSRP) strength.

In some implementations, the signal strength measured is a reference signal indicator (RSSI).

The details of one or more embodiments of these systems and methods are set forth in the accompanying drawings and the description below. Other features, objects, and advantages of these systems and methods will be apparent from the description and drawings, and from the claims.

### BRIEF DESCRIPTION OF THE FIGURES

FIG. 1 illustrates a wireless network, according to some implementations.

FIG. 2 illustrates a flowchart of an example method for transmitting SL-PRS using a shared resource pool, according to some implementations.

FIG. 3A illustrates a conceptual diagram of the relative bandwidths used by physical sidelink shared channel (PSSCH), physical sidelink shared channel (PSSCH)/physical sidelink feedback channel (PSFCH), and sidelink positioning reference signal (SL-PRS) for a shared resource for a single PSSCH/PSFCH, according to some implementations.

FIG. 3B illustrates a conceptual diagram of the relative bandwidths used by physical sidelink shared channel (PSSCH), physical sidelink shared channel (PSSCH)/physical sidelink feedback channel (PSFCH), and sidelink positioning reference signal (SL-PRS) for a shared resource across multiple PSSCH/PSFCH, according to some implementations.

FIG. 3C illustrates another conceptual diagram of the relative bandwidths used by physical sidelink shared channel (PSSCH), physical sidelink shared channel (PSSCH)/physical sidelink feedback channel (PSFCH), and sidelink positioning reference signal (SL-PRS) for a shared resource for a single PSSCH/PSFCH, according to some implementations.

FIG. 4 illustrates a flowchart of a method for synchronization and Intra-Band Emission (IBE) Interference control performed by an Rx UE, according to some implementations.

FIG. 5 illustrates a flowchart of a method for synchronization and IBE control performed by a Tx UE, according to some implementations.

FIG. 6 illustrates a flow diagram of a typical double-sided RTT flow, according to some implementations.

FIG. 7 illustrates a flow diagram of a general double-sided RTT without transmission order restriction, according to some implementations.

FIG. 8 illustrates an example user equipment (UE), according to some implementations.

FIG. 9 illustrates an example access node, according to some implementations.

### DETAILED DESCRIPTION

The present disclosure generally relates to sidelink and double-sided round trip time (RTT) positioning for shared resource pools. In some implementations, the present disclosure provides a multiplexing frame structure for sidelink positioning using shared resource pools. The solutions provided herein enable methods for handling synchronization and inter-band emission (IBE) interference. In addition, the solutions provided herein enable on-demand sidelink positioning reference signal (SL-PRS) transmission and physical layer requests for SL-PRS transmission. In other implementations, the present disclosure provides methods device positioning using double-sided RTT. The solutions provided herein enable double-sided RTT positioning without order restriction and specify the content of feedback for double-sided RTT positioning.

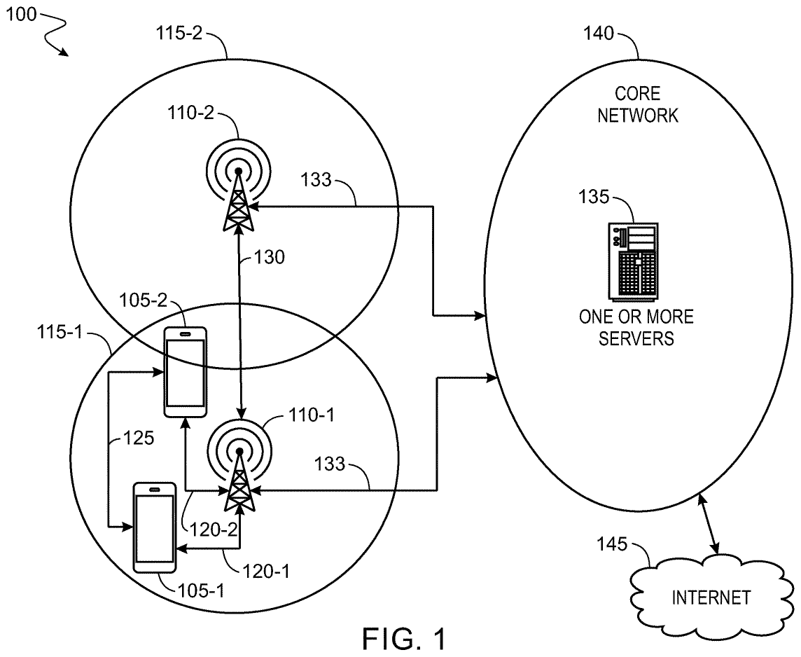

FIG. 1 illustrates a wireless network 100, according to some implementations. The wireless network 100 includes a UE 102 and a base station 104 connected via one or more channels 106A, 106B across an air interface 108. The UE 102 and base station 104 communicate using a system that supports controls for managing the access of the UE 102 to a network via the base station 104.

In some implementations, the wireless network 100 may be a Non-Standalone (NSA) network that incorporates Long Term Evolution (LTE) and Fifth Generation (5G) New Radio (NR) communication standards as defined by the Third Generation Partnership Project (3GPP) technical specifications. For example, the wireless network 100 may be a E-UTRA (Evolved Universal Terrestrial Radio Access)-NR Dual Connectivity (EN-DC) network, or an NR-EUTRA Dual Connectivity (NE-DC) network. In some other implementations, the wireless network 100 may be a Standalone (SA) network that incorporates only 5G NR. Furthermore, other types of communication standards are possible, including future 3GPP systems (e.g., Sixth Generation (6G)), Institute of Electrical and Electronics Engineers (IEEE) 802.11 technology (e.g., IEEE 802.11a; IEEE 802.11b; IEEE 802.11g; IEEE 802.11-2007; IEEE 802.11n; IEEE 802.11-2012; IEEE 802.11ac; or other present or future developed IEEE 802.11 technologies), IEEE 802.16 protocols (e.g., WMAN, WiMAX, etc.), or the like. While aspects may be described herein using terminology commonly associated with 5G NR, aspects of the present disclosure can be applied to other systems, such as 3G, 4G, and/or systems subsequent to 5G (e.g., 6G).

In the wireless network 100, the UE 102 and any other UE in the system may be, for example, any of laptop computers, smartphones, tablet computers, machine-type devices such as smart meters or specialized devices for healthcare, intelligent transportation systems, or any other wireless device. In network 100, the base station 104 provides the UE 102 network connectivity to a broader network (not shown). This UE 102 connectivity is provided via the air interface 108 in a base station service area provided by the base station 104. In some implementations, such a broader network may be a wide area network operated by a cellular network provider, or may be the Internet. Each base station service area associated with the base station 104 is supported by one or more antennas integrated with the base station 104. The service areas can be divided into a number of sectors associated with one or more particular antennas. Such sectors may be physically associated with one or more fixed antennas or may be assigned to a physical area with one or more tunable antennas or antenna settings adjustable in a beamforming process used to direct a signal to a particular sector.

The UE 102 includes control circuitry 110 coupled with transmit circuitry 112 and receive circuitry 114. The transmit circuitry 112 and receive circuitry 114 may each be coupled with one or more antennas. The control circuitry 110 may include various combinations of application-specific circuitry and baseband circuitry. The transmit circuitry 112 and receive circuitry 114 may be adapted to transmit and receive data, respectively, and may include radio frequency (RF) circuitry and/or front-end module (FEM) circuitry.

In various implementations, aspects of the transmit circuitry 112, receive circuitry 114, and control circuitry 110 may be integrated in various ways to implement the operations described herein. The control circuitry 110 may be adapted or configured to perform various operations, such as those described elsewhere in this disclosure related to a UE.

Additionally, the transmit circuitry 112 may transmit using a plurality of multiplexed uplink physical channels. The plurality of uplink physical channels may be multiplexed, e.g., according to time division multiplexing (TDM) or frequency division multiplexing (FDM) along with carrier aggregation. The transmit circuitry 112 may be configured to receive block data from the control circuitry 110 for transmission across the air interface 108.

Additionally, the receive circuitry 114 may receive a plurality of multiplexed downlink physical channels from the air interface 108 and relay the physical channels to the control circuitry 110. The plurality of downlink physical channels may be multiplexed, e.g., according to TDM or FDM along with carrier aggregation. The transmit circuitry 112 and the receive circuitry 114 may transmit and receive, respectively, both control data and content data (e.g., messages, images, video, etc.) structured within data blocks that are carried by the physical channels.

FIG. 1 also illustrates the base station 104. In some implementations, the base station 104 may be a 5G radio access network (RAN), a next generation RAN, a E-UTRAN, a non-terrestrial cell, or a legacy RAN, such as a UTRAN. As used herein, the term “5G RAN” or the like may refer to the base station 104 that operates in an NR or 5G wireless network 100, and the term “E-UTRAN” or the like may refer to a base station 104 that operates in an LTE or 4G wireless network 100. The UE 102 utilizes connections (or channels) 106A, 106B, each of which includes a physical communications interface or layer.

The base station 104 circuitry may include control circuitry 116 coupled with transmit circuitry 118 and receive circuitry 120. The transmit circuitry 118 and receive circuitry 120 may each be coupled with one or more antennas that may be used to enable communications via the air interface 108. The transmit circuitry 118 and receive circuitry 120 may be adapted to transmit and receive data, respectively, to any UE connected to the base station 104. The receive circuitry 120 may receive a plurality of uplink physical channels from one or more UEs, including the UE 102.

In FIG. 1, the one or more channels 106A, 106B are illustrated as an air interface to enable communicative coupling, and can be consistent with cellular communications protocols, such as a UMTS protocol, a 3GPP LTE protocol, an Advanced long term evolution (LTE-A) protocol, a LTE-based access to unlicensed spectrum (LTE-U), a 5G protocol, a NR protocol, an NR-based access to unlicensed spectrum (NR-U) protocol, and/or any other communications protocol(s). In implementations, the UE 102 may directly exchange communication data via a ProSe interface. The ProSe interface may alternatively be referred to as a sidelink (SL) interface and may include one or more logical channels, including but not limited to a Physical Sidelink Control Channel (PSCCH), a Physical Sidelink Discovery Channel (PSDCH), and a Physical Sidelink Broadcast Channel (PSBCH).

The present disclosure generally relates to sidelink and double-sided round trip time (RTT) positioning for shared resource pools. In some implementations, the present disclosure provides a multiplexing frame structure for sidelink positioning using shared resource pools. The solutions provided herein enable methods for handling synchronization and inter-band emission (IBE) interference. In addition, the solutions provided herein enable on-demand sidelink positioning reference signal (SL-PRS) transmission and physical layer requests for SL-PRS transmission. In other implementations, the present disclosure provides methods device positioning using double-sided RTT. The solutions provided herein enable double-sided RTT positioning without order restriction and specify the content of feedback for double-sided RTT positioning.

### Multiplexing Frame Structure for Shared Resource Pool

Comb-based multiplexing of SL PRS from different UEs in a slot for dedicated resource pools is to be supported. The agreement presents questions of how to support comb-based and TDM multiplexing for shared resource pools. In addition, how should synchronization and Inter-Band interference be handled. The present disclosure provides multiple different frame structures for SL-PRS. The frame structure is, for example, where the SL-PRS is multiplexed. For comb-based multiplexing, mechanisms are described to facilitate addressing multiple UEs, and mitigate the effects of loss of synchronization and inter-band interference. For TDM, this disclosure describes mechanisms to facilitate addressing multiple UEs.

In some implementations, SL-PRS is located in any symbol within the shared resource pool. SL-PRS is transmitted within a single shared resource pool containing a single PSSCH/PSFCH transmission. In such implementations, the bandwidth of SL-PRS is less than or equal to the bandwidth of the resource pool. In some implementations, comb-based multiplexing occurs with SL-PRS time-and-frequency (T-F) resources.

In other implementations, SL-PRS is located in a dedicated slot within the shared resource pool. SL-PRS transmitted within a single shared resource pool but may span a frequency resource greater than the single PSSCH/PSFCH transmission. In such implementations, the bandwidth of SL-PRS can be ≤bandwidth of PSSCH. Alternatively, in such implementations, the bandwidth of SL-PRS can be greater than bandwidth of PSSCH. In some implementations, comb-based multiplexing occurs with SL-PRS T-F resources.

In other implementations, SL PRS is located in any symbol or a dedicated slot within a set of shared resource pools. SL-PRS may span a frequency resource that encompasses multiple independent SL-PSSCH/PSFCH transmissions between multiple pairs of UEs. In such implementations, the bandwidth of SL-PRS is greater than bandwidth of each PSSCH.

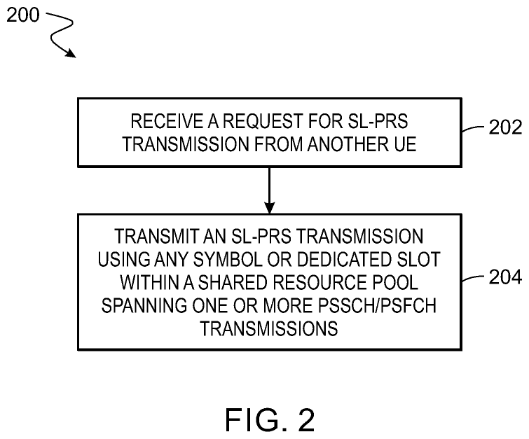

FIG. 2 illustrates a flowchart of an example method 200 for transmitting SL-PRS using a shared resource pool, according to some implementations. The method 200 will be described as being performed by a UE such as the UE 105 or the UE 800.

A UE can begin performance of the method 200 by receiving a request for sidelink positioning reference signal (SL-PRS) transmission from another UE (202).

The UE can continue execution of the method 200 by transmitting an SL-PRS transmission using any symbol or dedicated slot within a shared resource pool containing a one or more physical sidelink shared channel (PSSCH)/physical sidelink feedback channel (PSFCH) transmissions (204).

In some implementations, the bandwidth of the SL-PRS is less than or equal to the bandwidth of the shared resource pool. An example of this scenario is represented by the diagram 300A, where the bandwidth of the SL-PRS 330A is equal to the bandwidth of the shared resource pool in PSSCH/PSFCH 320A.

In some implementations, the comb-based multiplexing is used with SL-PRS T-F resources.

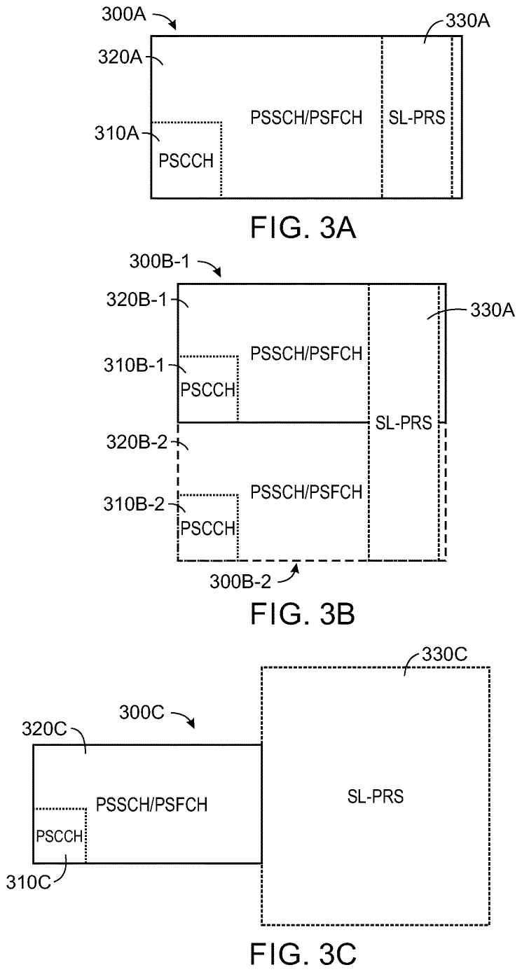

In some implementations, the bandwidth of the SL-PRS is greater than the bandwidth of PSSCH. An example of this scenario is represented by the diagram 300C in FIG. 3C, where the bandwidth of the SL-PRS 330C is shown as greater than the bandwidth of the shared resource pool represented in PSSCH/PSFCH 320C.

In some implementations, comb-based multiplexing occurs with SL-PRS time and frequency (T-F) resources.

In some implementations, transmitting an SL-PRS transmission using any symbol or dedicated slot within a shared resource pool containing a one or more PSSCH/PSFCH transmissions can include the UE transmitting an SL-PRS transmission using any symbol or dedicated slot within a shared resource pool containing multiple PSSCH/PSFCH transmissions.

In some implementations, the bandwidth of the SL-PRS is greater than the bandwidth of each of the PSSCH transmissions. An example of this scenario is represented by diagram 300B-1 and 300B-2 in FIG. 3B, where the bandwidth of SL-PRS 330B is greater than the bandwidth of each of the PSSCH transmissions 320B-1, 320B-2.

### Comb Based Multiplexing

Some implementations are directed to comb-based multiplexing of SL PRS from different UEs in a slot for shared resource pools. In some instances, no comb-based multiplexing for SL PRS from different UEs in a slot for shared resource pool is supported.

Alternatively, in a second implementation, comb-based multiplexing is allowed. In this second implementation, a need is there to enable signaling of additional SL PRS Source(s) and SL PRS Destination(s). In some implementations, this need can be met using a new SCI-stage 2 with S ID/D ID(s) for communication and Source ID(s)/Destination ID(s) for SL PRS Tx/Rx. In some implementations, communication and positioning S/D are separately signaled (may need to signal # of S/D positioning pairs). In other implementations, communication and positioning S/D are jointly signaled.

In some implementations, solutions are provided to manage the impact of synchronization and IBE interference. Regarding synchronization, UEs that perform comb-based multiplexing have common synchronization source. Regarding, Intra-Band Emission (IBE) interference and Power control, solutions are proposed that ensure that the power level at all receiver UEs is limited to within a threshold.

In some implementations, a common source is used to ensure same power level. In other implementations, SL-PRS multiplexing groups can be created that ensure a difference in power is less than a threshold. In such implementations, each UE may feedback all communication session UEIDs (or source UE IDs or other identifiers) that arrive at an acceptable power based on the power received from their signals (e.g. their PSSCH transmission/power control) via Sidelink LTE Positioning Protocol (SL LPP) (e.g. as assistance information). The information may be reported to the multiplexing selector, such as an LMF, a side-link LMF or an UE elected or configured to perform the identification (a server UE). For comb-based multiplexing between multiple pairs, a multiplexing selector identifies specific UE pairs that can be multiplexed to ensure that all received SL PRS are within a threshold based on the reported feedback.

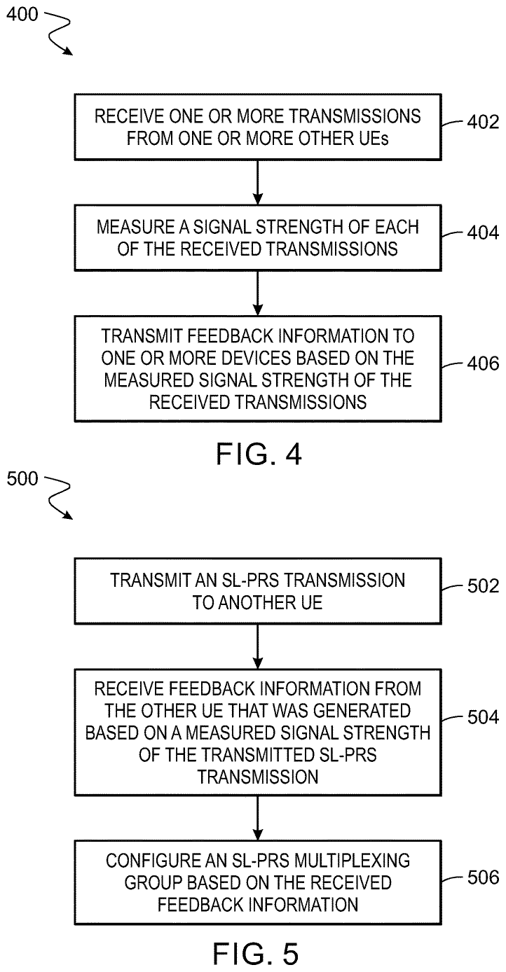

FIG. 4 illustrates a flowchart of a method 400 for synchronization and Intra-Band Emission (IBE) Interference control performed by an Rx UE, according to some implementations. The method 400 will be described as being performed by a UE such as the UE 105 or the UE 800.

A UE can begin execution of the method 400 by receiving one or more transmissions from one or more other UEs (402).

The UE can continue execution of the method 400 by measuring a signal strength of each of the received transmissions (404).

The UE can continue execution of the method 400 by transmitting feedback information to one or more devices based on the measured signal strength of each of the received transmissions (406).

In some implementations, the one or more transmissions received at stage 402 are sidelink positioning reference signal (SL-PRS) transmissions, the signal strength measured at stage 404 is the signal strength of each of the received SL-PRS transmissions, and the feedback information transmitted to one or more devices at stage 406 is based on measured signal strength of each of the received SL-PRS transmissions. In such implementations, the signal strength that is measured at stage 404 can be a reference signal received power (RSRP), a reference strength signal indicator (RSSI), or any other power measure, of the received SL-PRS transmissions.

In some implementations, one or more transmissions received at stage 402 are PSCCH transmissions, the signal strength measured at stage 404 is the signal strength of each of the received PSCCH transmissions, and the feedback information transmitted to one or more devices at stage 406 is based on measured signal strength of each of the received PSCCH transmissions. In such implementations, the signal strength that is measured at stage 404 can be a reference signal received power (RSRP), a reference strength signal indicator (RSSI), or any other power measure, of the received PSCCH transmissions.

In some implementations, one or more transmissions received at stage 402 are PSFCH transmissions, the signal strength measured at stage 404 is the signal strength of each of the received PSFCH transmissions, and the feedback information transmitted to one or more devices at stage 406 is based on measured signal strength of each of the received PSFCH transmissions. In such implementations, the signal strength that is measured at stage 404 can be the received power of the PSFCH transmission.

In some implementations, the feedback transmission at stage 406 is transmitted using sidelink control information (SCI).

In some implementations, receiving SL-PRS transmission from one or more other UEs can include the UE receiving SL-PRS transmission from one other UE.

In some implementations, the feedback information comprises one or more UEIDs that each correspond to UEID from which an SL-PRS transmission was received that satisfied a predetermined RSRP threshold.

In some implementations, the one or more devices comprises an location management function (LMF).

In some implementations, the other one or more devices comprises the other UEs.

FIG. 5 illustrates a flowchart of a method 500 for synchronization and IBE control performed by a Tx UE, according to some implementations. The method 500 will be described as being performed by a UE such as the UE 105 or the UE 800.

A UE can begin execution of the process 500 by transmitting a sidelink positioning reference signal (SL-PRS) transmission to another UE (502).

The UE can continue execution of the process 500 by receiving feedback information from the other UE that was generated based on a measured signal strength of the transmitted SL-PRS transmission (504).

The UE can continue execution of the process 500 by configuring an SL-PRS multiplexing group based on the received feedback information (506).

In some implementations, the measured signal strength is a reference signal received power (RSRP) strength.

In some implementations, the measured signal strength measured is a reference strength signal indicator (RSSI).

In some implementations, the SL-PRS transmission is transmitted using sidelink control information (SCI).

In some implementations, the feedback information comprises one or more UEIDs that each correspond to UEID of a UE that transmitted an SL-PRS transmission that satisfied a predetermined RSRP threshold.

In some implementations, UEs that can be comb-based multiplexed are pre-configured. The network is responsible to ensure synchronization and power levels

The process 500 considers a scenario where the UE has already transmitted an SL-PRS transmission. However, in a scenario where the UE has not transmitted a SL-PRS yet, the measurement in the feedback information may be based on a measurement of another signal transmitted by the UEs such as, e.g. PSCCH, PSSCH, PSFCH, CSI-RS, or PT-RS.

### TDM Based Multiplexing

In some implementations, TDM-based multiplexing of SL PRS from different UEs in a slot for shared resource pools is disclosed. In some implementations, no TDM-based multiplexing of SL PRS from different UEs in a slot for shared resource pools. In other implementations, TDM-based multiplexing of SL PRS from different UEs in a slot for shared resource pools. To facilitate the latter implementation, an update to addressing to allow signaling of SL-PRS Source(s) and SL-PRS Destination(s) is required. Such an update can be similar solution to comb-based multiplexing solutions.

Double Sided RTT without Order Restriction

Movement towards SL-PRS-based RX-TX measurements for double-sided round trip time (RTT) opened questions pertaining to how to differentiate between different PRS transmissions for sidelink PRS RX-TX measurements and reporting, as well as how to feedback measurements to support both doubled sided RTT types. This disclosure describes order differentiation for doubled sided RTT, where implicit and explicit signaling for measurements and feedback to indicate a type of double sided RTT. Also described herein is feedback for doubled-sided RTT, where specific feedback that is needed for either the ordered or non-ordered double-sided RTT can be indicated.

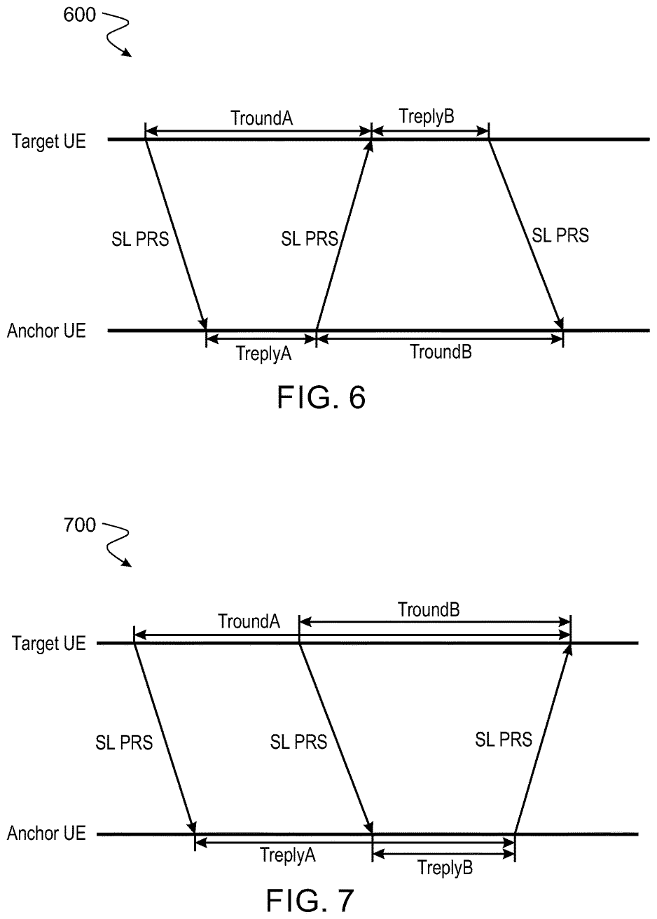

FIG. 6 illustrates a flow diagram 600 of a typical double-sided RTT flow, according to some implementations. FIG. 7 illustrates a flow diagram 700 of a general double-sided RTT without transmission order restriction, according to some implementations.

Given the flow diagrams in FIGS. 6 and 7, the propagation time between the target and ancho UEs can be estimated as:

$$T = \frac{TroundA \times TroundB - TreplyA \times TreplyB}{TroundA + TroundB + TreplyA + TreplyB}$$

The present disclosure provides solutions that differentiate different PRS transmissions for sidelink PRS Rx-Tx measurement and report.

### Order Differentiation for Double Sided RTT

In some implementations, signaling can be employed to indicate differentiation of measurement type. Measurement types can be explicit or implicit. For example, in some implementations, signaling can be employed to configure a UE to use explicit measurement. In such implementations, signaling can be employed to explicitly configure a UE to use an SL-RTT configuration that uses (a) double sided RTT or (b) order of double-sided RTT. In other implementations, signaling can be employed to configure a user to use implicit measurement. Implicit measurement can include resource allocation that identifies a number of consecutive SL-PRS transmissions for UE-A. In some implementations, signaling may reserve resource for reply for UE-B.

In some implementations, signaling can be employed to indicate differentiation of feedback type. Feedback type can be explicit or implicit. In some implementations, for example, explicit feedback can include a flag indicating in/out of order. On the other hand, in some implementations, for example, implicit feedback received from UE after SL-PRS transmissions implicitly indicates double-sided RTT order. In some implementations, feedback can include information on specific SL-PRS resource(s) which implicitly identifies the order. In some implementations, feedback can include a time stamp of when the SL-PRS was sent and/or received which implicitly identifies the order.

Examples 1-11 relate to order differentiation for RTT.

The present disclosure also provides solutions for using feedback measurements to support both double sided RTT types.

### Feedback for Double-Sided RTT

In some implementations, measurement for typical case may need to report TreplyA and TroundB from Anchor UE. In a first implementations, Rx-Tx time difference may be based on closest subframe. For example, for feedback: T2−T1, T6−T5, estimate: TroundA (from T4 and T1), TreplyA (from TroundA, T2−T1 and T4−T3), TreplyB (from T5−T4), and TroundB {from (T6−T5)+(T5−T4)+(T4−T3). In a second implementations, Rx-Tx time difference may be based on actual SL-PRS transmission time. For example, for feedback: T3−T2 (TreplyA) and T6 OR T6−T3 (TroundB), estimate: TroundA (from T4 and T3) and TreplyB (from T5−T4).

In some implementations, measurement for non-ordered case may need to report TreplyA and TreplyB. In a first implementations, Rx-Tx time difference may be based on closest subframe. For example, for feedback: T2−T1, T6−T5, estimate: TroundA (T3−T1), TroundB (T3−T5), TreplyA {TroundA−(T3−T4)−T2−T1)}, TreplyB {TroundB−(T4−T3)−{T6−T5)}. In a second implementations, Rx-Tx time difference may be based on actual SL-PRS transmission time. For example, for feedback: T4−T2 (TreplyA) and T4−T6 (TreplyB), estimate: TroundA (from T1 and T3) and TroundB (from T3 and T5).

Examples 12-13 relate to feedback for double sided RTT.

### On-Demand PRS for SL-Positioning

In some implementations, on-demand SL-PRS transmission procedure allows a transmitting UE, a receiving UE, LMF and/or a SL-LMF to control and decide whether SL-PRS is transmitted or not and to change the characteristics of an ongoing SL-PRS transmission. The on-demand SL-PRS transmission procedure can be initiated either by the transmitting UE (self-triggering), the receiving UE (other UE triggering), the LMF (in-coverage) or the SL-LMF (out-of-coverage).

In some implementations, a transmitting and/or a receiving UE may initiate on-demand SL-PRS. In some implementations, a transmitting UE, receiving UE and/or an LMF (in-coverage) may initiate on-demand SL-PRS. In some implementations, a transmitting UE, a receiving UE and/or an SL-LMF (out-of-coverage) may initiate on-demand SL-PRS.

In some implementations, SL-PRS changes can be a pre-defined SL-PRS configuration with a SL-PRS configuration ID, an explicit parameter for the SL-PRS configuration, a request to transmit/receive SL-PRS or a request for measurement. For example, in a first implementation, the actual SL-PRS changes are requested by the LMF irrespective of whether the procedure is UE- or LMF-initiated if an LMF is involved (in-coverage). In a second implementation, the actual SL-PRS changes are requested by the SL-LMF irrespective of whether the procedure is UE- or SL-LMF-initiated if a SL-LMF is involved (out-of-coverage). In a third implementation, the actual SL-PRS changes can be requested by a primary UE where the primary UE may be (pre-)configured as the on-demand SL-PRS primary. In a fourth implementation, the actual SL-PRS changes can be requested by any of the UEs i.e. the primary or the secondary UE.

In general, the overall procedure is as follows. First, information is exchanged via SL-LPP (SL-LMF to or from SL-UE(s)). For example, SL-PRS configurations are exchanged. This can include, for example, exchange of identification of on-demand SL-PRS primary. Note that, in the case of self-triggering, the SL-LPP signal is to the UE itself. Second, on-demand PRS requests are exchanged. For UE-initiated for a pre-defined PRS configuration ID or explicit PRS configuration parameter, the UE may request for SL-PRS transmission or change to the SL-PRS transmission characteristics. This may be a self-trigger or a trigger from another UE (a primary UE). For SL-LMF initiated, obtain UE measurements, change PRS transmission characteristics.

Examples 14-25 relate to on-demand PRS for SL-positioning.

### PHY Layer Request for SL-PRS Transmission

In some implementations, the UE may use the PSFCH channel to support UE-A requesting UE-B to transmit SL-PRS via lower layer signaling sent by UE-A. In some implementations, the transmit/receive UE pair may be configured with the PSFCH resource (and sequence) during configuration of the SL-PRS. According to a first implementation, a single resource is configured per SL-PRS. The use of the resource may be for a single request or to turn on/off a periodic SL-PRS for semi-persistent operation. Alternatively, in accordance with a second implementation, one or two resources may be configure per SL-PRS. In this second implementation, if there is one PSFCH resource, this is used to request an aperiodic transmission of the SL-PRS. On the other hand, if there are two resources in this second implementation (for a periodic SL-PRS), one may be used to start the SP transmission and one may be used to stop the periodic transmission.

In some implementations, it may be possible that some PRBs in the PSFCH symbol are not used. In this case, the UE may be (pre-)configured to use these resources to request UE-B transmit SL-PRS. If the UE is scheduled to transmit a PSFCH in response to a PSSCH transmission, the PSFCH for the PSCCH transmission may have greater priority.

In some implementations, the UE may use a SL-PRS Request signal in the SCI to support UE-A requesting UE-B to transmit SL-PRS via lower layer signaling sent by UE-A. For dedicated resource pools with a single stage SCI, the SL-PRS request signal is a field in the SCI. For shared resource pools with a 2-stage SCI, the SL-PRS request signal is a field in the SCI-stage 2. It is up to UE-B's own higher layers to transmit SL-PRS in response to the lower layer request from UE-A. In one implementation, an on-demand SL-PRS transmission procedure can be initiated by the transmitting UE-B (self-triggering).

In some implementations, the UE may use a MAC-CE in the PSSCH to support UE-A requesting UE-B to transmit SL-PRS via lower layer signaling sent by UE-A.

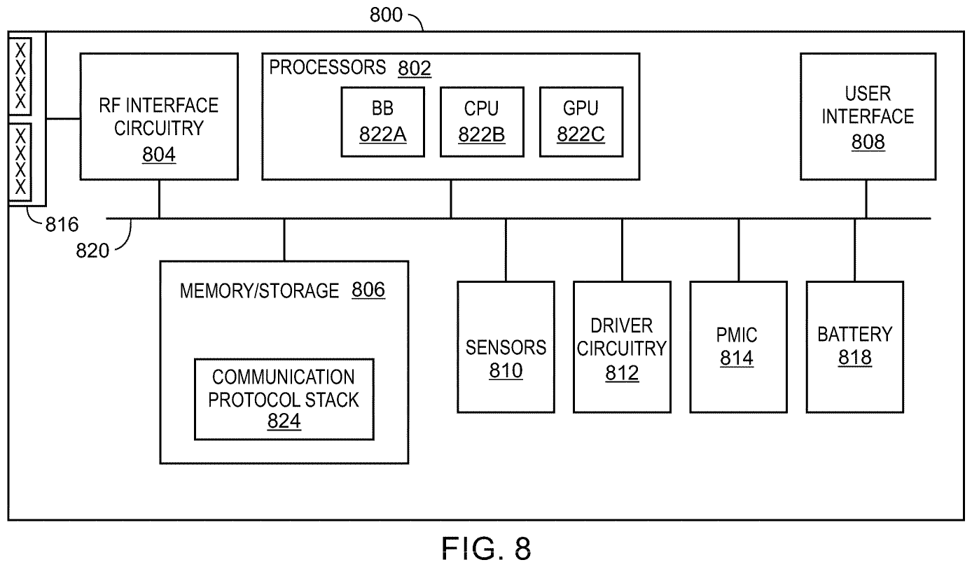

FIG. 8 illustrates an example UE 800, according to some implementations. The UE 800 may be similar to and substantially interchangeable with UE 102 of FIG. 1.

The UE 800 may be any mobile or non-mobile computing device, such as, for example, mobile phones, computers, tablets, industrial wireless sensors (for example, microphones, pressure sensors, thermometers, motion sensors, accelerometers, inventory sensors, electric voltage/current meters, etc.), video devices (for example, cameras, video cameras, etc.), wearable devices (for example, a smart watch), relaxed-IoT devices.

The UE 800 may include processors 802, RF interface circuitry 804, memory/storage 806, user interface 808, sensors 810, driver circuitry 812, power management integrated circuit (PMIC) 814, one or more antenna(s) 816, and battery 818. The components of the UE 800 may be implemented as integrated circuits (ICs), portions thereof, discrete electronic devices, or other modules, logic, hardware, software, firmware, or a combination thereof. The block diagram of FIG. 8 is intended to show a high-level view of some of the components of the UE 800. However, some of the components shown may be omitted, additional components may be present, and different arrangement of the components shown may occur in other implementations.

The components of the UE 800 may be coupled with various other components over one or more interconnects 820, which may represent any type of interface, input/output, bus (local, system, or expansion), transmission line, trace, optical connection, etc. that allows various circuit components (on common or different chips or chipsets) to interact with one another.

The processors 802 may include processor circuitry such as, for example, baseband processor circuitry (BB) 822A, central processor unit circuitry (CPU) 822B, and graphics processor unit circuitry (GPU) 822C. The processors 802 may include any type of circuitry or processor circuitry that executes or otherwise operates computer-executable instructions, such as program code, software modules, or functional processes from memory/storage 806 to cause the UE 800 to perform operations as described herein.

In some implementations, the baseband processor circuitry 822A may access a communication protocol stack 824 in the memory/storage 806 to communicate over a 3GPP compatible network. In general, the baseband processor circuitry 822A may access the communication protocol stack to: perform user plane functions at a physical (PHY) layer, medium access control (MAC) layer, radio link control (RLC) layer, packet data convergence protocol (PDCP) layer, service data adaptation protocol (SDAP) layer, and PDU layer; and perform control plane functions at a PHY layer, MAC layer, RLC layer, PDCP layer, RRC layer, and a non-access stratum layer. In some implementations, the PHY layer operations may additionally/alternatively be performed by the components of the RF interface circuitry 804. The baseband processor circuitry 822A may generate or process baseband signals or waveforms that carry information in 3GPP-compatible networks. In some implementations, the waveforms for NR may be based cyclic prefix orthogonal frequency division multiplexing (OFDM) “CP-OFDM” in the uplink or downlink, and discrete Fourier transform spread OFDM “DFT-S-OFDM” in the uplink.

The memory/storage 806 may include one or more non-transitory, computer-readable media that includes instructions (for example, communication protocol stack 824) that may be executed by one or more of the processors 802 to cause the UE 800 to perform various operations described herein. The memory/storage 806 include any type of volatile or non-volatile memory that may be distributed throughout the UE 800. In some implementations, some of the memory/storage 806 may be located on the processors 802 themselves (for example, L1 and L2 cache), while other memory/storage 806 is external to the processors 802 but accessible thereto via a memory interface. The memory/storage 806 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 804 may include transceiver circuitry and radio frequency front module (RFEM) that allows the UE 800 to communicate with other devices over a radio access network. The RF interface circuitry 804 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna(s) 816 and proceed to filter and amplify (with a low-noise amplifier) the signal. The signal may be provided to a receiver of the transceiver that downconverts the RF signal into a baseband signal that is provided to the baseband processor of the processors 802.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna(s) 816. In various implementations, the RF interface circuitry 804 may be configured to transmit/receive signals in a manner compatible with NR access technologies.

The antenna(s) 816 may include one or more antenna elements to convert electrical signals into radio waves to travel through the air and to convert received radio waves into electrical signals. The antenna elements may be arranged into one or more antenna panels. The antenna(s) 816 may have antenna panels that are omnidirectional, directional, or a combination thereof to enable beamforming and multiple input, multiple output communications. The antenna(s) 816 may include microstrip antennas, printed antennas fabricated on the surface of one or more printed circuit boards, patch antennas, phased array antennas, etc. The antenna(s) 816 may have one or more panels designed for specific frequency bands including bands in FR1 or FR2.

The user interface 808 includes various input/output (I/O) devices designed to enable user interaction with the UE 800. The user interface 808 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs), or more complex outputs such as display devices or touchscreens (for example, liquid crystal displays “LCDs,” LED displays, quantum dot displays, projectors, etc.), with the output of characters, graphics, multimedia objects, and the like being generated or produced from the operation of the UE 800.

The sensors 810 may include devices, modules, or subsystems whose purpose is to detect events or changes in its environment and send the information (sensor data) about the detected events to some other device, module, subsystem, etc. Examples of such sensors include, inter alia, inertia measurement units including accelerometers, gyroscopes, or magnetometers; microelectromechanical systems or nanoelectromechanical systems including 3-axis accelerometers, 3-axis gyroscopes, or magnetometers; level sensors; temperature sensors (for example, thermistors); pressure sensors; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 812 may include software and hardware elements that operate to control particular devices that are embedded in the UE 800, attached to the UE 800, or otherwise communicatively coupled with the UE 800. The driver circuitry 812 may include individual drivers allowing other components to interact with or control various input/output (I/O) devices that may be present within, or connected to, the UE 800. For example, driver circuitry 812 may include a display driver to control and allow access to a display device, a touchscreen driver to control and allow access to a touchscreen interface, sensor drivers to obtain sensor readings of sensors 810 and control and allow access to sensors 810, drivers to obtain actuator positions of electro-mechanic components or control and allow access to the electro-mechanic components, a camera driver to control and allow access to an embedded image capture device, audio drivers to control and allow access to one or more audio devices.

The PMIC 814 may manage power provided to various components of the UE 800. In particular, with respect to the processors 802, the PMIC 814 may control power-source selection, voltage scaling, battery charging, or DC-to-DC conversion.

In some implementations, the PMIC 814 may control, or otherwise be part of, various power saving mechanisms of the UE 800. A battery 818 may power the UE 800, although in some examples the UE 800 may be mounted deployed in a fixed location, and may have a power supply coupled to an electrical grid. The battery 818 may be a lithium ion battery, a metal-air battery, such as a zinc-air battery, an aluminum-air battery, a lithium-air battery, and the like. In some implementations, such as in vehicle-based applications, the battery 818 may be a typical lead-acid automotive battery.

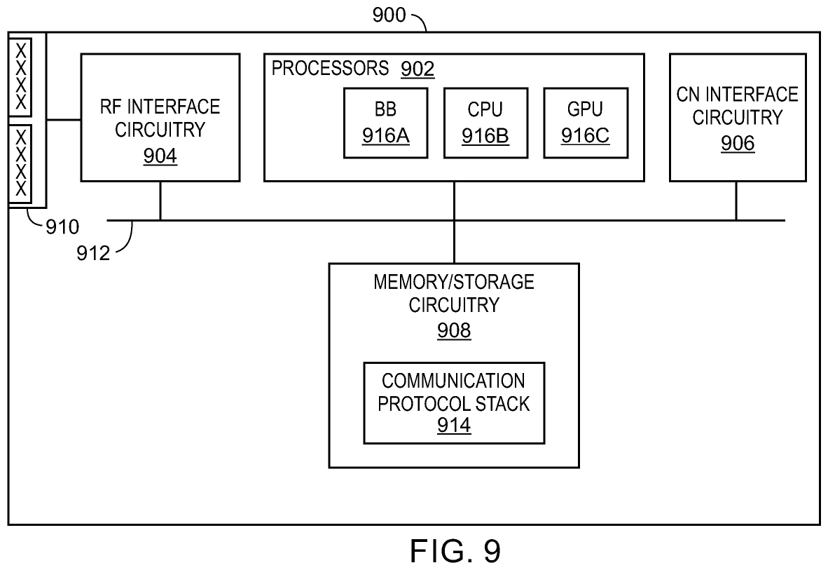

FIG. 9 illustrates an example access node 900 (e.g., a base station or gNB), according to some implementations. The access node 900 may be similar to and substantially interchangeable with base station 104. The access node 900 may include processors 902, RF interface circuitry 904, core network (CN) interface circuitry 906, memory/storage circuitry 908, and one or more antenna(s) 910.

The components of the access node 900 may be coupled with various other components over one or more interconnects 912. The processors 902, RF interface circuitry 904, memory/storage circuitry 908 (including communication protocol stack 914), antenna(s) 910, and interconnects 912 may be similar to like-named elements shown and described with respect to FIG. 8. For example, the processors 902 may include processor circuitry such as, for example, baseband processor circuitry (BB) 916A, central processor unit circuitry (CPU) 916B, and graphics processor unit circuitry (GPU) 916C.

The CN interface circuitry 906 may provide connectivity to a core network, for example, a 5th Generation Core network (5GC) using a 5GC-compatible network interface protocol such as carrier Ethernet protocols, or some other suitable protocol. Network connectivity may be provided to/from the access node 900 via a fiber optic or wireless backhaul. The CN interface circuitry 906 may include one or more dedicated processors or FPGAs to communicate using one or more of the aforementioned protocols. In some implementations, the CN interface circuitry 906 may include multiple controllers to provide connectivity to other networks using the same or different protocols.

As used herein, the terms “access node,” “access point,” or the like may describe equipment that provides the radio baseband functions for data and/or voice connectivity between a network and one or more users. These access nodes can be referred to as BS, gNBs, RAN nodes, eNBs, NodeBs, RSUs, TRxPs or TRPs, and so forth, and can include ground stations (e.g., terrestrial access points) or satellite stations providing coverage within a geographic area (e.g., a cell). As used herein, the term “NG RAN node” or the like may refer to an access node 900 that operates in an NR or 5G system (for example, a gNB), and the term “E-UTRAN node” or the like may refer to an access node 900 that operates in an LTE or 4G system (e.g., an eNB). According to various implementations, the access node 900 may be implemented as one or more of a dedicated physical device such as a macrocell base station, and/or a low power (LP) base station for providing femtocells, picocells or other like cells having smaller coverage areas, smaller user capacity, or higher bandwidth compared to macrocells.

In some implementations, all or parts of the access node 900 may be implemented as one or more software entities running on server computers as part of a virtual network, which may be referred to as a CRAN and/or a virtual baseband unit pool (vBBUP). In V2X scenarios, the access node 900 may be or act as a “Road Side Unit.” The term “Road Side Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

In the following sections, further exemplary embodiments are provided.

Example 1 includes a UE that receives signaling that is configured to indicate an sidelink round trip time (SL-RTT) measurement type; and configuring the UE to implement the SL-RTT measurement type indicated by the received signaling.

Example 2 includes where the signaling of Example 1 indicates an explicit measurement type.

Example 3 includes where explicit measurement type of Example 2 comprises an SL-RTT configuration that indicates (a) use of double sided RTT, (b) order of double-sided RTT, or both.

Example 4 includes where the signaling of Example 1 indicates an implicit measurement type.

Example 5 includes where implicit measurement type of Example 4 comprises resource allocation 2 identifies a number of consecutive SL-PRS transmissions for UE-A.

Example 6 includes where implicit measurement type of Example 4 comprises reserving resources for reply for UE-B

Example 7 includes a UE that receives signaling that is configured to indicate an SL-RTT feedback type; and configuring the UE to implement the feedback type indicated by the received signaling.

Example 8 includes where the signaling of Example 7 indicates an explicit feedback type.

Example 9 includes where the explicit feedback type of Example 8 includes a flag indicating in/out of order.

Example 10 includes where the signaling of Example 7 indicates an implicit feedback type.

Example 11 includes where the implicit feedback type of Example 10 indicates that feedback received from UE after SL-PRS transmission implicitly indicates double-sided RTT order.

Example 11 includes where the implicit feedback type of Example 10 indicates that UE feedback may also include information on specific SL-PRS resource(s) which identifies order.

Example 12 includes receiving a double-sided RTT measurement transmission, and transmitting feedback based on the received double-sided RTT measurement transmission, wherein the transmitted feedback is an Rx-Tx time difference based on closest subframe.

Example 13 includes receiving a double-sided RTT measurement transmission, and transmitting feedback based on the received double-sided RTT measurement transmission, wherein the transmitted feedback is an Rx-Tx time difference based on actual SL-PRS transmission time.

Example 14 includes determining, by a first device, to initiate transmission of one or more SL-PRS transmissions; and transmitting, by the first device, one or more SL-PRS transmissions.

Example 15 includes determining, by the first device that characteristics of the ongoing transmission of the one or more SL-PRS transmissions is to change, and changing characteristics of the ongoing SL-PRS transmission based on the determined characteristic change.

Example 16 includes Example 15 wherein the first device is a transmitting UE, a receiving UE, an LMF, or an SL-LMG.

Example 14 includes receiving, by a first device and from a second device, a transmission indicating that one or more SL-PRS transmissions are to be initiated, determining, by the first device, to initiate transmission of one or more SL-PRS transmission based on the received transmission, and transmitting, by the first device, one or more SL-PRS transmissions.

Example 15 includes Example 14 wherein the first device is a receiving UE.

Example 16 includes Example 14 wherein the second device is a transmitting UE, an LMF, or an SL-LMG.

Example 17 includes Example 14 further comprising receiving, by the first device and from the second device, a transmission indicating that characteristics of the ongoing transmission of the one or more SL-PRS transmissions is to change, and changing, by the first device, characteristics of the ongoing SL-PRS transmission based on the determined characteristic change.

Example 18 includes Example 17 wherein the first device is a receiving UE.

Example 19 includes Example 17 wherein the second device is a transmitting UE, an LMF, or an SL-LMG.

Example 20 includes Example 15 or Example 17 where a change to SLPRS transmission can be a change in pre-defined SL-PRS configuration.

Example 21 includes Example 20 where the pre-defined SL-PRS configuration can include an SL-PRS configuration ID, an explicit parameter for an SL-PRS configuration, a request to transmit/receive SL-PRS, or a request for measurement.

Example 22 can include one or more of Examples 14-21 where actual SL-PRS changes are requested by the LMF irrespective of whether the procedure is UE-initiated or LMF-initiated if an LMF is involved.

Example 23 can include one or more of Examples 14-21 where actual SL-PRS changes can be requested by the SL-LMF irrespective of whether the procedure is UE-initiated or SL-LMF-initiated if an SL-LMF is involved.

Example 24 can include one or more of Examples 14-21 where actual SL-PRS changes can be requested by a primary UE where the primary UE may be (pre-)configured as an on demand SL-PRS primary.

Example 25 can include one or more of Examples 14-21 where actual SL-PRS changes can be requested by any of the UEs (e.g., a primary UE or a secondary UE).

Example 26 can include transmitting, by a UE-A, a request in PSFCH, to a UE-B, that requests UE-B to transmit SL-PRS via lower layer signaling, and receiving, by UE-A and from UE-B, transmission of SL-PRs via lower layer signaling from UE-B.

Example 27 can include Example 26 where a single resource is configured per SL-PRS.

Example 28 can include Example 27 where use of the resource may be for a single request to turn on/off a periodic SL-PRS for semi-persistent operation.

Example 29 can include Example 26 where one or two resources are configured per SL-PRS.

Example 30 can include Example 29 where one PSFCH resource is used to request a periodic transmission of the SL-PRS.

Example 31 can include Example 29 where two PSFCH resources are used, one of the two PSFCH resources can be used to start the periodic SL-PRS transmission and the other of the two PSFCH resources can be used to stop the periodic SL-PRS transmission.

Example 32 can include Example 26 where UE-A determining that one or more physical resource blocks (PRBs) in PSFCH are not being utilized; and transmitting, by the UE-A, a request, to UE-B, to transmit SL-PRS using the PRBs in PSFCH that were not being utilized.

Example 33 can include one or more of Examples 26-32 where if the UE-A is scheduled to transmit a PSFCH in response to a PSSCH transmission, the PSFCH for the PSCCH transmission may have greater priority.

Example 34 can include Example 26 where the request for SL-PRS is transmitted in SCI.

Example 35 can include Example 34 where the SCI is a single stage SCI, wherein the SL-PRS request signal is a field in the SCI.

Example 36 can include Example 34 where SCI is a 2-stage SCI, wherein the SL_PRS request signal is a field in the SCI-stage 2.

Example 37 can include Example 26 where the request for SL-PRS is transmitted using MAC-CE in the PSSCH.

Example 38 can include example 37, where the UE identifier can include a UEID or a session ID.

Example 39 can include example 35, where the signal strength measured is a reference signal received power (RSRP) strength.

Example 40 can include example 35, where the signal strength measured is a reference signal indicator (RSSI).

Example 41 is a method for sidelink positioning, the method including: transmitting a sidelink positioning reference signal (SL-PRS) transmission to another UE; receiving feedback information from the other UE that was generated based on a measured signal strength of the transmitted SL-PRS transmission; and configuring an SL-PRS multiplexing group based on the received feedback information.

Example 42 is the method 41, where the feedback information is transmitted using sidelink control information (SCI).

Example 43 is the method of claim 41, where the feedback information includes one or more UE identifiers that each correspond to a UE that transmitted an SL-PRS transmission that satisfied a predetermined signal strength threshold.

Example 44 is the method of claim 43, where the UE identifier can include a UEID or a session ID.

Example 45 is the method of claim 41, where the signal strength measured is a reference signal received power (RSRP) strength.

Example 46 is the method of claim 41, where the signal strength measured is a reference signal indicator (RSSI).

Example 47 is a method performed by a user equipment (UE), the method including: determining a time difference for sidelink reception time T_{UE-RX} and transmission time T_{UE-TX}; where: T_{UE-RX} includes a timing for the reception of a sidelink subframe #i, and T_{UE-TX} is one of: a transmit timing of a sidelink subframe #j of a sidelink positioning reference signal of the UE, or a transmit timing of sidelink subframe #j that is closest in time to the sidelink subframe #i received.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1-47. (canceled)

48. One or more processors configured to, when executing instructions stored in a memory, perform operations comprising:
receiving a first sidelink subframe from a first user equipment (UE);
determining a reception time of a second UE based on received timing of the first sidelink subframe from the first UE;
determining a transmission time of the second UE based on transmit timing of a second sidelink subframe; and
determining a sidelink time difference at the second UE based on the determined reception time and the determined transmission time.

49. The one or more processors of claim 48, wherein the second sidelink subframe comprises a subframe that is closest in time to the first sidelink subframe received from the first UE.

50. The one or more processors of claim 48, wherein the second sidelink subframe comprises a subframe of a sidelink positioning reference signal (SL PRS) from the second UE.

51. The one or more processors of claim 50, wherein the second UE is configured to report a transmission timestamp of the SL PRS.

52. The one or more processors of claim 50, wherein the operations comprise transmitting the SL PRS using a SL PRS resource within a shared SL PRS resource pool.

53. The one or more processors of claim 52, wherein the SL PRS resource comprises one or more consecutive symbols within a slot of the shared SL PRS resource pool.

54. The one or more processors of claim 52, wherein comb-based multiplexing of SL PRS resources from different UEs in a slot of the shared SL PRS resource pool is not supported.

55. The one or more processors of claim 52, wherein time-division multiplexing (TDM)-based multiplexing of SL PRS transmissions from different UEs in a slot of the shared SL PRS resource pool is not supported.

56. The one or more processors of claim 52, wherein the SL PRS and a physical sidelink shared channel (PSSCH) transmission are mapped to different symbols of the shared SL PRS resource pool.

57. The one or more processors of claim 56, wherein the SL PRS is mapped to one or more symbols before, between, or after symbols that are mapped to the PSSCH transmission.

58. The one or more processors of claim 56, wherein a bandwidth of the SL PRS is equal to a bandwidth of the PSSCH.

59. The one or more processors of claim 52, wherein the operations comprise receiving second stage sidelink control information (SCI) that requests transmission of the SL PRS from the second UE.

60. The one or more processors of claim 48, wherein the operations comprise measuring a double-sided round trip time (RTT) between the first UE and the second UE based at least in part on the sidelink time difference.

61. A method comprising:
receiving a first sidelink subframe from a first UE;
determining a reception time of a second UE based on received timing of the first sidelink subframe from the first UE;
determining a transmission time of the second UE based on transmit timing of a second sidelink subframe; and
determining a sidelink time difference at the second UE based on the determined reception time and the determined transmission time.

62. The method of claim 61, wherein the second sidelink subframe comprises a subframe that is closest in time to the first sidelink subframe received from the first UE.

63. The method of claim 61, wherein the second sidelink subframe comprises a subframe of an SL PRS from the second UE.

64. The method of claim 63, wherein the second UE is configured to report a transmission timestamp of the SL PRS.

65. The method of claim 63, comprising transmitting the SL PRS using a SL PRS resource within a shared SL PRS resource pool.

66. The method of claim 65, wherein the SL PRS resource comprises one or more consecutive symbols within a slot of the shared SL PRS resource pool.

67. The method of claim 65, wherein comb-based multiplexing of SL PRS resources from different UEs in a slot of the shared SL PRS resource pool is not supported.
